(19) United States
(12) Patent Application Publication
(10) Pub. No.: US 2026/0152435 A1
(43) Pub. Date: Jun. 4, 2026

(54) HIGH SOLIDS LIQUID BINDERS

(71) Applicant: Owens Corning Intellectual Capital, LLC, Toledo, OH (US)

(72) Inventors: Gert Rainer Julius Mueller, New Albany, OH (US); Xiujuan Zhang, New Albany, OH (US); Nathalie Bea Milbrandt, Westerville, OH (US)

(21) Appl. No.: 19/405,959

(22) Filed: Dec. 2, 2025

Related U.S. Application Data
(60) Provisional application No. 63/727,327, filed on Dec. 3, 2024.
(60) Provisional application No. 63/857,204, filed on Aug. 4, 2025.

(51) Int. Cl. C03C 25/285; C08F 8/14; C09D 133/02

(52) U.S. Cl. CPC C03C 25/285; C08F 8/14; C09D 133/02

(57) ABSTRACT

A fibrous insulation product is disclosed comprising a plurality of randomly oriented fibers and a binder composition at least partially coating the fibers. Prior to cure, the binder composition comprises an aqueous composition including at least 35 wt. % of a reactive diluent polyol having a mol-equivalent weight per OH group of at least 40 and 20 wt. % to less than 70 wt. % of a polymeric crosslinking agent. The aqueous binder composition has a viscosity that is at least 10% less than a substantially similar aqueous binder composition that includes monomeric polyol rather than a multifunctional oligomeric polyol, at the same temperature and solids content.

### CROSS-REFERENCE TO RELATED APPLICATIONS

This application claims priority to U.S. Provisional Application No. 63/857,204, filed on Aug. 4, 2025, and U.S. Provisional Application No. 63/727,327, filed on Dec. 3, 2024, the entire contents of each being incorporated by reference herein.

### BACKGROUND

Aqueous binder compositions are conventionally utilized in the formation of woven and non-woven fibrous products, such as insulation products, composite products, wood fiber board, and the like. Insulation products, for example insulation products formed of inorganic fibers, are typically manufactured by fiberizing a molten glass or mineral-based composition and spinning fibers from a fiberizing apparatus. To form an insulation product, a binder material is sprayed onto the fibers and the fibers are collected into a high loft, continuous blanket on the conveyor. The binder material gives the insulation product resiliency for recovery after packaging and provides stiffness and handleability so that the insulation product can be handled and applied as needed in the insulation cavities of buildings. The binder composition also provides protection to the fibers from interfilamentous abrasion and promotes compatibility between the individual fibers. The blanket containing the binder-coated fibers is then passed through a curing oven and the binder is cured to set the blanket to a desired thickness.

After the binder has cured, the fiber insulation may be cut into lengths to form individual insulation products, and the insulation products may be packaged for shipping to customer locations. Insulation products prepared in this manner can be provided in various forms including batts, blankets, and boards (heated and compressed batts) for use in different applications.

Alternatively, the formed, uncured blanket, containing the binder-coated fibers, can be further rolled up in a winding machine to form rolls or logs that are stored and later cured. The uncured rolls or logs can be stored for multiple days, before they are cut into proper lengths and formed into desired shape before curing, to better fit equipment and end application configurations such as pipe, partition walls, headliners, and hood liners. This long storage time is needed, for example, to meet plant operation scheduling needs. As a result, the uncured rolls or logs of insulation can require a longer shelf life during this storage period.

Mineral fiber products generally comprise man-made vitreous fibers (MMVF), such as glass fibers, ceramic fibers, basalt fibers, slag wool, mineral wool, and stone wool, which are bound together by a polymeric binder composition. Traditional binder compositions used for mineral fiber insulation, and particularly mineral wool insulation, are based on phenol-formaldehyde (PF) resins, as well as PF resins extended with urea (PUF resins). However, while such binder compositions provide suitable properties to the insulation products, formaldehyde binders emit undesirable emissions during the manufacturing process and there has been a desire to move away from the use of formaldehyde-based binders.

As an alternative to formaldehyde-based binders, certain formaldehyde-free or no added formaldehyde (“NAF”) formulations have been developed for use as binders in insulation products. Such NAF formulations may include a polycarboxylic acid and a polyol or polyhydroxy that are intended to crosslink via an esterification reaction.

Conventional NAF binder compositions can present challenges when used to form insulation required to have a longer shelf life (i.e., at least two days) before it is cured. Conventional formaldehyde-based binder systems would allow for such storage and would retain softness and flexibility throughout the roll. However, NAF binders have proven more difficult in this type of situation, since, for instance, the outer layer of the formed roll tends to dry out when stored prior to curing, making the roll too rigid and causes the uncured blanket to break while being formed into a desired shape (e.g., pipe). This also causes the layers of the insulation to stick together, thus requiring longer processing times, all decreasing productivity and efficiency, as well as the performance of the final insulation product.

Furthermore, although the outer layer of the formed roll tends to dry out more quickly, merely increasing moisture amounts can result in insulation rolls that are not uniform, as moisture increases tension of the uncured blanket, which then forms wrinkles and bubbles during rolling.

Prior attempts to maintain adequate moisture in the outer layer of an insulation roll during uncured storage include, for example, increasing the amount of water in the binder. However, increasing the water content of a binder composition results in increased moisture among the inner layers of the roll as well, which causes curing inconsistencies and impedes downstream cutting. Additional prior attempts have included adding more binder to the fibers and increasing the loss on ignition or “LOI” (the measure of how much binder is applied to fiber products, measured by the weight difference after burning off the organic binder components). However, increasing LOI causes stickiness, bubbling, and wrinkling of the insulation while it is undergoing winding, decreasing the quality of the shape formed.

Accordingly, an improved NAF binder composition is needed for use in the production of fibrous insulation products with extended shelf-life, excellent mechanical performance, high LOI (i.e., 5-10%), and sufficient processing properties.

### SUMMARY

Various exemplary aspects of the present inventive concepts are directed to an aqueous binder composition comprising a reactive diluent polyol that is a liquid at room temperature and at a high solids content, which lowers the viscosity of the binder composition and allows for a decreased concentration of polyacids, while still producing fibrous insulation products with good recovery and performance.

Aspects of the invention provide a fibrous insulation product comprising a plurality of randomly oriented fiber and a binder composition at least partially coating the fibers. The binder composition is an aqueous composition prior to cure, which comprises at least 35 wt. % of a reactive diluent polyol having a mol-equivalent weight per OH group of at least 40 and 20 wt. % to less than 70 wt. % of a polymeric crosslinking agent. The aqueous binder composition has a viscosity that is at least 10% less than a substantially similar aqueous binder composition that includes monomeric polyol rather than a multifunctional oligomeric polyol, at the same temperature and solids content.

The reactive diluent polyol is a multifunctional oligomeric polyol having a degree of polymerization of 2, 3, 4, or 5, and may comprise, for example, polyglycerol. The reactive diluent polyol is a liquid at a solids content of 75% and above, such as a solids content of 85% or above, 90% or above, 95% or above, and 99% or above, at ambient temperature.

In some aspects, the binder composition further includes a secondary polyol comprising one or more of a sugar alcohol, pentaerythritol, and alkanolamine, which may be present in the binder composition in an amount less than 30 wt. %, or preferably less than about 20%.

The crosslinking agent, reactive diluent polyol, and any optional secondary polyols are present in the binder composition in amounts such that the ratio of the number of molar equivalents of carboxylic acid groups, anhydride groups, or salts thereof to the number of molar equivalents of hydroxyl groups (COOH:OH) is from about 1:3 to about 3:1, such as from about 1.5:1 to 1:1.5, and has no greater than 6% by weight of water-soluble material after cure.

Further aspects of the invention are directed to an aqueous binder composition for forming a fibrous insulation product, characterized in that the aqueous binder composition has a viscosity at a temperature of 25° C. of less than 5,000 cP at 73% solids. The aqueous binder composition comprises at least 35 wt. % of a reactive diluent polyol, wherein the reactive diluent polyol has a mol-equivalent weight per OH group of at least 40 and is substantially in liquid form at a solids content above 75% and 20 wt. % to 70 wt. % by weight of a polymeric crosslinking agent comprising at least two carboxylic acid groups.

Further aspects of the invention are directed to a method for forming a fibrous insulation product comprising forming an uncured insulation blanket from a plurality of randomly oriented fibers at least partially coated with an aqueous binder composition, and curing the insulation blanket to form a fibrous insulation product. The aqueous binder composition comprises at least 35 wt. % of a reactive diluent polyol, wherein the reactive diluent polyol has a mol-equivalent weight per OH group of at least 40 and is substantially in liquid form at a solids content above 75%. The aqueous binder composition further includes 20 wt. % to 70 wt. % by weight of a polymeric crosslinking agent.

In any of the inventive aspects, the fibrous insulation product is uncured pipe insulation.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

The general inventive concepts, as well as illustrative embodiments and advantages thereof, are described below in greater detail, by way of example, with reference to the drawings in which:

FIG. 1 illustrates a typical method for producing a fiberglass insulation product according to the present invention.

FIG. 2 graphically illustrates the Load/LOI performance of various handsheets prepared in accordance with the present invention, compared to those prepared with conventional binder compositions.

FIG. 3 graphically illustrates the Young's modulus/LOI performance of various handsheets prepared in accordance with the present invention, compared to those prepared with conventional binder compositions.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

By “substantially free” it is meant that a composition includes less than 1.0 wt. % of the recited component, including no greater than 0.8 wt. %, no greater than 0.6 wt. %, no greater than 0.4 wt. %, no greater than 0.2 wt. %, no greater than 0.1 wt. %, and no greater than 0.05 wt. %. In any of the exemplary embodiments, “substantially free” means that a composition includes no greater than 0.01 wt. % of the recited component.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the fibrous product and vice versa; features described herein in relation to the method may be applicable to the aqueous binder composition and vice versa; and features described herein in relation to the fibrous product may be applicable to the aqueous binder composition and vice versa.

Every numerical range given throughout this specification and claims will include every narrower numerical range that falls within such broader numerical range, as if such narrower numerical ranges were all expressly written herein.

The present disclosure relates to formaldehyde-free or “no added formaldehyde” aqueous binder compositions for use with inorganic fibers, such as glass or mineral wool fibers. As used herein, the terms “binder composition,” “aqueous binder composition,” “binder formulation,” “binder,” and “binder system’ may be used interchangeably and are synonymous. Additionally, as used herein, the terms “formaldehyde-free” or “no added formaldehyde” may be used interchangeably and are synonymous.

The binder composition may be used in the manufacture of fiber insulation products and related products, such as fiber-reinforced mats, veils, nonwovens, etc. (all hereinafter referred to generically as fibrous products). The binder composition may particularly be used with inorganic fibers, such as fiberglass or mineral wool products, such as fiberglass insulation products, made with the cured binder composition, or with mineral wool insulation products. Other products may include composite products, wood fiber board products, metal building insulation, pipe insulation, ceiling board, ceiling tile, “heavy density” products, such as board products including, for example, ceiling board, duct board, foundation boards, pipe and tank insulation, sound absorption boards, acoustical panels, general board products, duct liners, and also “light density” products including, for example, residential insulation, duct wrap, metal building insulation, flexible duct media. Further fibrous products include non-woven fiber mats and particle boards, and composite products manufactured therefrom.

Although this disclosure will be described as fiberglass insulation herein, it should be noted that this disclosure applies to other inorganic fibrous insulation products, including but not limited to mineral wool insulation products.

The invention is directed to improved formaldehyde-free binder compositions for use in the manufacture of insulation products that allow for reduced moisture levels on a curing oven ramp to below 5%, or below 2%, based on uncured product weight. As a product enters a curing oven, it travels up a “ramp” and, on such a ramp, insulation products must have a sufficiently low moisture content in order for the moisture to be fully removed during the cure process. Additionally, the insulation products must still be loose and well recovered on the ramp, despite the low moisture content. Conventional binder chemistries demonstrate that ramp moisture levels of 2% or less result in product property losses, such as reduced recovery and stiffness.

The inventive binder therefore provides the ability to reduce ramp moisture while producing a fibrous insulation product with sufficient recovery and good performance. Reduced ramp moisture is particularly important in the manufacture of insulation products with reduced fiber diameters and reduced density, as such products are more resistant to air flow.

### Fibers

The term “fibrous insulation product” is general and encompasses a variety of compositions, articles of manufacture, and manufacturing processes. The fibrous insulation products of the present disclosure comprise a plurality of randomly oriented fibers. In certain exemplary embodiments, the plurality of randomly oriented fibers are inorganic fibers, including, but not limited to glass fibers, glass wool fibers, mineral wool fibers, slag wool fibers, stone wool fibers, ceramic fibers, metal fibers, and combinations thereof.

Optionally, the fibers may include natural fibers and/or synthetic fibers such as carbon, polyester, polyethylene, polyethylene terephthalate, polypropylene, polyamide, aramid, and/or polyaramid fibers may be used in the non-woven fiber mats. The term “natural fiber” as used herein refers to plant fibers extracted from any part of a plant, including, but not limited to, the stem, seeds, leaves, roots, or phloem. Examples of natural fibers suitable for use as the reinforcing fiber material include wood fibers, cellulosic fibers, straw, wood chips, wood strands, cotton, jute, bamboo, ramie, bagasse, hemp, coir, linen, kenaf, sisal, flax, henequen, and combinations thereof.

The fibrous insulation products may be formed entirely of one type of fiber, or they may be formed of a combination of types of fibers. For example, the fibrous insulation products may be formed of combinations of various types of glass fibers or various combinations of different inorganic fibers and/or natural fibers depending on the desired application. In any of the embodiments disclosed herein, the insulation products are formed entirely of glass fibers.

The fibrous insulation product may be formed from glass fibers of any conventional fiber diameter, such as, for example, 4 μm (16 HT) to 15 μm (60 HT). According to some aspects, the fibrous insulation product may include glass fibers having a smaller diameter than the glass fibers used in conventional fiberglass insulation products. In particular, the exemplary fibrous insulation product may include glass fibers having an average fiber diameter that is less than 4 μm (16 HT), less than 3.5 μm (14 HT), less than 3 μm (12 HT), less than 2.5 μm (10 HT), or less than 2 μm (8 HT), or less than 1.5 μm (6 HT), or less than 1 μm (4 HT). For example, the glass fibers may have fiber diameters in the range of 2 μm (8 HT) to 3.75 μm (15 HT), in the range of 2.5 μm (10 HT) to 3.5 μm (14 HT), or in the range of 2.75 μm (11 HT) to 3.25 μm (13 HT), including all endpoints and subranges therebetween. In some aspects, the fibrous insulation product includes a blend of glass fibers having an average fiber diameter greater than 4 microns and glass fibers having an average fiber diameter that is less than 4 microns. In other aspects, the fibrous insulation product may include glass fibers formed entirely from fibers having an average fiber diameter greater than 4 microns.

The procedure used to measure the fiber diameters of the glass fibers utilizes a scanning electron microscope (SEM) to directly measure fiber diameter. In general, a specimen of the fibrous insulation product is heated to remove any organic materials (e.g., binder composition), the glass fibers from the specimen are then reduced in length and photographed by the SEM. The diameters of the fibers are then measured from the saved images by imaging software associated with the SEM.

More specifically, a specimen of the fibrous insulation product is heated to 800° F. for a minimum of 30 minutes. The specimen may be heated longer if required to ensure removal of any organic materials. The specimen is then cooled to room temperature and the glass fibers are reduced in length in order to fit onto an SEM planchette. The glass fibers may be reduced in length by any suitable method, such as for example, cut by scissors, chopped by a razor blade, or ground in a mortar and pestle. The glass fibers are then adhered to the surface of the SEM planchette such that the fibers are not overlapping or spaced too far apart.

Once the specimen is prepared for imaging, the specimen is mounted in the SEM using normal operating procedures and photographed by the SEM at appropriate magnification for the diameter size of the fibers being measured. A variety of images are collected and saved to ensure enough fibers are available for measuring. For example, 10 to 13 images may be required where 250 to 300 fibers are being measured. The fiber diameters are then measured using an SEM image analysis software program, such as, for example, Scandium SIS imaging software. Average fiber diameter of the specimen is then determined from the number of fibers measured. The fibrous insulation product specimen may include glass fibers that are fused together (i.e., two or more fibers joined along their lengths). For the purpose of calculating the average fiber diameter of specimens in the present disclosure, fused fibers are treated as single fibers.

### Binder Composition

Binder compositions are typically applied to the fibers as an aqueous solution or dispersion shortly after the fibers are formed. The binders are then cured at elevated temperatures, or curing occurs after the insulation products undergo storage for a period of time. As used herein, “dispersion” includes all forms of solids dispersed in a liquid medium, regardless of the size of the particle or properties of the dispersion, including true “solutions” in which the solids are soluble and dissolved in the liquid medium. The curing conditions of the binder composition are selected both to evaporate any remaining solvent and cure the binder to a thermoset state. The fibers in the resulting product tend to be at least partially coated with a thin layer of the thermoset resin and exhibit accumulations of the binder composition at points where fibers touch or are positioned closely adjacent to each other.

Conventional NAF binder compositions include, for example, those formed via an esterification reaction between at least one polyacid and at least one polyol. However, as mentioned above, conventional NAF binders have shown to dry out when stored at ambient temperatures, causing the formation of a film or “skin” layer on the binder composition.

However, it has been surprisingly discovered that certain polyols, when used in particular concentrations and ratios, improve the shelf-life of uncured binder compositions and the overall processability of a resulting fibrous insulation product formed therefrom, as compared with conventional NAF binder compositions, even at a high level of binder solids.

Particularly, the inclusion of a reactive diluent in an NAF binder composition lowers the viscosity of the binder composition, even at high binder solid percentages (i.e., at least 70% solids). The improved binder composition results in a product capable of being used in downstream forming processes, such as a pipe forming/winding process, etc. The low viscosity at high binder solids provides more uniform distribution of the binder, resulting in better recovery of the insulation product on the ramp, prior to cure. The uncured binder composition is also less sticky on the oven chain, which also leads to better uniformity and recovery. As a result, less moisture is needed in the insulation product on the ramp, and less heat is needed for complete curing.

The phrase ‘reactive diluent,” as used herein, refers to a multifunctional polyol that remains substantially in liquid form at a high solids concentration and ambient temperature (15° C.-20° C.). The term “substantially,” as used herein, means at least 75%, and in some instances, at least 85%, and in some instances, at least 95%, and in yet other instances, 100%. Particularly, the reactive diluent is substantially in liquid form at a solids content of above 70% at ambient temperature. In any of the exemplary aspects, the reactive diluent is substantially in liquid form at a solids content of 75% and above, including, for example, at a solids content of 80% and above, at a solids content of 85% and above, at a solids content of 90% and above, at a solids content of 95% and above, and a solids content of 100%, at ambient temperature. In contrast, conventional NAF binder compositions have been manufactured using, for example, sorbitol or other monomeric polyols that remain in liquid form at a maximum solids content of 70% or less at ambient temperature.

Exemplary reactive diluents include multifunctional oligomeric polyols. Exemplary oligomeric polyols include liquid polyols and particularly polyols with 2 to 10 OH groups per unit, such as, for example 2 OH groups, 3 OH groups, 4 OH groups, 5 OH groups, 6 OH groups, 7 OH groups, etc. Exemplary oligomeric polyols include polyglycerol, polyether polyols, polyester polyols, ethoxylated or propoxylated pentaerythritol, ethoxylated or propoxylated trimethylol propane, and the like.

With specific reference to polyglycerol, the polyglycerol is an oligomer distribution that may include diglycerol components, triglycerol components, tetraglycerol components, hexaglycerol components, etc., and mixtures thereof. As used herein, the oligomer distribution in polyglycerol is measured by gel permeation chromatography (GPC)/size exclusion chromatography (SEC). GPC may be performed using any equipment and process known and available to those skilled in the art. In one example, similar to the method outlined in U.S. Pat. No. 8,704,005, the GPC is performed using a high-performance liquid chromatography (HPLC)/ultra high-performance liquid chromatography (UHPLC) system equipped with an Agilent PL Aquagel-OH column, using water as the mobile phase and a refractive index detector. The samples are dissolved in water and filtered through a 0.45 micrometer disposable membrane filter (millipore), prior to injection. A calibration curve is developed with polyethylene glycol standards (Agilent). The data is processed using the HPLC manufacture's software.

Alternative methods can be used, such as gas chromatography (GC), as described in WO2018140447A1.

In particularly preferred aspects, the polyglycerol oligomer is formed of at least 25% diglycerol, or at least 30% diglycerol, or at least 50% diglycerol, or at least 60% diglycerol, at least 70% diglycerol, at least 75% diglycerol, at least 80% diglycerol, at least 85% di glycerol, at least 90% diglycerol, and at least 95% diglycerol. It has been discovered that smaller polyglycerol oligomers begin to crosslink sooner than larger oligomers, which facilitates the use of a faster line speed and lower cure temperatures. Low cure temperatures allow for higher cross-link density. Accordingly, the polyglycerol includes less than 30% tetraglycerol components or higher (pentaglycerol, hexaglycerol, etc.), including, for example, less than 25%, less than 22%, less than 20%, less than 15%, less than 10%, less than 5%, and less than 2%.

The polyglycerol oligomer includes at least 50% of a combination of di- and triglycerol components, such as, for example, at least 55%, at least 60%, at least 65%, at least 70%, at least 75%, or at least 80%. In some aspects, the polyglycerol oligomer includes at least 50% of the combination of di- and triglycerol components, with at least 25% being diglycerol components.

In some aspects, the polyglycerol includes at least 25% diglycerol components and less than 30% tetraglycerol or larger components. In some aspects, the polyglycerol is substantially a diglycerol and includes at least 50% diglycerol components or the polyglycerol is substantially a triglycerol and includes at least 40% triglycerol components.

In some aspects, the polyglycerol is a linear or branched polyglycerol oligomer. The oligomers preferably have a high content of linear polymers and minimal, if any, cyclic compounds. Cyclic polymers are less reactive, with a lower number of hydroxyl groups per molecule.

In some aspects, the polyglycerol has a hydroxyl number of at least 1000, including at least 1050, at least 1100, at least 1150, and at least 1200.

The polyglycerol may further be characterized by molecular weight. As used herein, the molecular weight values refer to number average molecular weight and are measured by the GPC/SEC or GC methods described above. The polyglycerol of the subject invention have a number-average molecular weight of 150 Da to 300 Da, including, for example, 160 Da to 290 Da, 175 Da to 280 Da, and 180 Da to 260 Da.

The reactive diluent polyol has a higher mol-equivalent weight per OH group than sorbitol, which has a mol-equivalent weight of 30.33. Therefore, the reactive diluent polyol provides a binder composition with the advantage of a lower viscosity at the same solids content, or requires less moisture content to achieve the same viscosity as conventional polyols, such as sorbitol. Additionally, the ratio of crosslinking agent, such as polyacrylic acid, can be proportionally reduced by the increased mol-equivalent weight of the reactive diluent polyol, without adversely affecting the COOH:OH ratio. In particular, the reactive diluent polyol has a mol-equivalent weight per OH group that is greater than 35, such as, for example, a mol-equivalent weight per OH group of at least 40, at least 42, at least 45, at least 50, at least 55, at least 75, at least 100, at least 125, at least 150, at least 175, and at least 200. With specific reference to polyglycerol, for example, polyglycerol a mol-equivalent weight per OH group of between about 40 and 55, such as about 41.5, 48, 52.33, or 55.4, respectively, assuming an average degree polymerization of 2, 3, 4, or 5).

In any of the embodiments disclosed herein, the binder composition may include the reactive diluent in an amount of at least 10 wt. %, including, for example, an amount of at least 12 wt. %, at least 15 wt. %, at least 20 wt. %, at least 25 wt. %, at least 30 wt. %, at least 35 wt. %, at least 37 wt. %, and at least 40 wt. %. Such amounts include a concentration of reactive diluent in the binder composition that includes from 20 to 75 wt. %, based on the total solids in the binder composition, including without limitation, an amount from 25 wt. % to 70 wt. %, 28 wt. % to 68 wt. %, 30 wt. % to 65 wt. %, 35 wt. % to 70 wt. %, 38 wt. % to 65 wt. %, 40 wt. % to 60 wt. %, and 45 wt. % to 58 wt. %, including all endpoints and subranges therebetween.

As mentioned above, aspects of the technical effect are achieved through the use of at least 10 wt. % of a reactive diluent that is substantially in liquid form at a solids content of above 70%, in combination with a polymeric crosslinking agent comprising at least two carboxylic acid groups. In any of the exemplary embodiments, the crosslinking agent may be a low molecular weight polymeric crosslinking agent. In such embodiments, the low molecular weight polymeric crosslinking agent may have a number-average molecular weight of less than or equal to 5,000 Daltons, including crosslinking agents having number-average molecular weights of less than or equal to 4,000 Daltons, less than or equal to 3,500 Daltons, less than or equal to 3,000 Daltons, less than or equal to 2,500 Daltons, less than or equal to 2,250 Daltons, less than or equal to 2,000 Daltons, less than or equal to 1,750 Daltons, less than or equal to 1,500 Daltons, and less than or equal to 1,250 Daltons. In any of the exemplary embodiments, the reactive diluent has a number-average molecular weight of 100 Daltons to 1,100 Daltons, including 250 Daltons to 900 Daltons, 350 Daltons to 750 Daltons, or has a number-average molecular weight that is no greater than 500 Daltons. As introduced above, the number-average molecular weight of the crosslinking agent is measured using GPC/SEC or GC analysis methods.

Non-limiting examples of suitable crosslinking agents include materials having one or more carboxylic acid groups (—COOH), such as monomeric and polymeric polycarboxylic acids, including salts or anhydrides thereof, and mixtures thereof. In any of the exemplary embodiments, the polycarboxylic acid may be a polymeric polycarboxylic acid, such as a homopolymer or copolymer of acrylic acid. The polymeric polycarboxylic acid may comprise polyacrylic acid (including salts or anhydrides thereof) and polyacrylic acid-based resins.

In any of the exemplary embodiments disclosed herein, the crosslinking agent may be present in the binder composition in an amount of at least 20 wt. %, based on the total solids content of the binder composition, including, without limitation at least 30 wt. %, at least 33 wt. %, at least 35 wt. %, at least 38 wt. %, at least 40 wt. %, at least 41 wt. %, at least 43 wt. %, at least 45 wt. %, at least 47 wt. %, and at least 50 wt. %. In any of the exemplary embodiments, the low molecular weight crosslinking agent may be present in the binder composition in an amount from 30% to 70% by weight, based on the total solids content of the binder composition, including without limitation 35% to 65% by weight, 37% to 60% by weight, and 40% to 58% by weight, including all endpoints and sub-combinations therebetween.

Optionally, the binder composition may further include at least one polyol having two or more hydroxyl groups (also referred to herein as a polyhydroxy compound), that is distinct from the reactive diluent introduced above (also referred to herein as a secondary polyol). In any of the exemplary embodiments, the secondary polyol may comprise one or more of monomeric or polymeric polyhydroxy compounds.

Exemplary secondary polyols include sugar alcohols, alkanolamines, mixtures thereof, or derivatives thereof. In any of the exemplary embodiments, the alkanolamine may comprise triethanolamine, or derivatives thereof. Accordingly, in some exemplary embodiments, the polyol comprises one or more of triethanolamine, derivatives thereof, or mixtures thereof.

Sugar alcohol is understood to mean compounds obtained when the aldo or keto groups of a sugar are reduced (e.g. by hydrogenation) to the corresponding hydroxy groups. The starting sugar might be chosen from monosaccharides, oligosaccharides, and polysaccharides, and mixtures of those products, such as syrups, molasses and starch hydrolyzates. The starting sugar also could be a dehydrated form of a sugar. Although sugar alcohols closely resemble the corresponding starting sugars, they are not sugars. Thus, for instance, sugar alcohols have no reducing ability, and cannot participate in the Maillard reaction typical of reducing sugars. In any of the exemplary embodiments, the sugar alcohol includes any of monoglycerol, arabitol, xylitol, sorbitol, maltitol, mannitol, iditol, isomaltitol, lactitol, cellobitol, palatinitol, maltotritol, syrups thereof, and mixtures thereof. In various exemplary embodiments, the sugar alcohol is selected from monoglycerol, sorbitol, xylitol, and mixtures thereof. In any of the exemplary embodiments, the polyol may be a dimeric or oligomeric condensation product of a sugar alcohol. In any of the exemplary embodiments, the condensation product of a sugar alcohol may be isosorbide. In any of the exemplary embodiments, the sugar alcohol may be a diol or glycol.

In some aspects, the binder composition may be free of reducing sugars. A reducing sugar is a type of carbohydrate or sugar that includes a free aldehyde or ketone group and can donate electrons to another molecule. As the binder composition is free of reducing sugars, it is unable to participate in a Maillard reaction, which is a process that occurs when a reducing sugar reacts with an amine. The Maillard reaction results in a binder composition with a brown color, which is undesirable for the subject binder composition.

According to certain aspects, the secondary polyol may include at least one carbohydrate that is natural in origin and derived from renewable resources. For instance, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate may also be derived from crude starch-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), and polysaccharides and water-soluble polysaccharides (e.g., pectin, dextrin, maltodextrin, starch, modified starch, and mixtures thereof).

The carbohydrate may be a carbohydrate polymer with a number average molecular weight from about 1,000 to about 8,000, measured using GPC/SEC or GC analysis, as detailed above. Additionally, the carbohydrate polymer may have a dextrose equivalent (DE) number from 2 to 20, from 7 to 11, or from 9 to 14. In at least one exemplary embodiment, the carbohydrate is a water-soluble polysaccharide such as dextrin or maltodextrin.

If present, the secondary polyol may be present in the binder composition in an amount up to about 30% by weight total solids, including without limitation, up to about 25%, about 20%, about 15%, about 12%, and about 10% by weight total solids. In any of the exemplary embodiments, the secondary polyol may be present in the binder composition in an amount from 0% to about 30% by weight total solids, including without limitation 2% to 25%, 3% to 20%, 5% to 18%, 8% to 15%, and 10% to 25%, by weight total solids, including all endpoints and sub-combinations therebetween.

In various exemplary embodiments, the cross-linking agent, reactive diluent, and any optional secondary polyols are present in amounts such that the ratio of the number of molar equivalents of carboxylic acid groups, anhydride groups, or salts thereof to the number of molar equivalents of hydroxyl groups (COOH: OH) is from about 0.07:1 to about 2.23:1, such as from about 0.17:1 to about 1:0.6, or from about 0.32:1 to about 0.92:1, or from about 0.4:1 to 0.6:1. In any of the exemplary embodiments, the aqueous binder composition may have a ratio of molar equivalents of carboxylic acid groups to hydroxyl groups that may be between 1:3 to 3:1, or between 0.60:1.0 and 1.0:0.6, or between 0.80:1 and 1.0:0.80. In certain aspects, the COOH: OH ratio is less than 1:1, including, for example, 1:1.1, 1:1.2, 1:1.3, 1:1.4, 1:1.5, and so on.

The COOH: OH ratio is important to provide a binder composition with a reduced level of water-soluble material post-cure, as determined by extracting water-soluble materials with deionized water for 2 hours at room temperature using about 1000 g of deionized water per about 1 gram of binder. The presence of water-soluble material post cure is indicative of incomplete curing and therefore weakened product properties, such as tensile strength and Young's modulus. Additionally, the higher the level of water-soluble material after cure, the more likely it is that a cured material suffers from leaching if/when exposed to water and/or a hot/humid environment. According to some aspects, the binder composition has no greater than 10% by weight of water-soluble material after cure. In some aspects, the binder composition has less than 6% by weight water-soluble material after cure, including less than 5.5% by weight, 5.0% by weight, 4.0 wt. %, 3.0% by weight, less than 2.5% by weight, less than 2.0% by weight less than 1.5% by weight, or less than 1.0% by weight. It has been discovered that reducing the level of water-soluble material after cure to no greater than 10% by weight, and preferably no greater than 6.0% by weight, will improve the tensile strength and Young's modulus of insulation products formed binder composition, as compared to an otherwise similar binder composition having a higher amount water soluble material after cure.

Optionally, the binder composition may include an esterification catalyst, also known as a cure accelerator. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, the catalyst may include an alkali metal salt of a phosphorous-containing organic acid, such as hypophosphorus acid; in particular, alkali metal salts of phosphorus acid, hypophosphorus acid, or polyphosphoric. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexametaphosphate, potassium phosphate, potassium tripolyphosphate, sodium trimetaphosphate, sodium tetrametaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also or alternatively be used as the catalyst.

The catalyst may be present in the binder composition in an amount from 0% to 10% by weight of the total solids in the binder composition, including without limitation, amounts from 0 to 5 wt. %, or from 0.5 wt. % to 4.5 wt. % by weight, or from 1.0 wt. % to 4.0 wt. %, or from 1.15 wt. % to 3.8 wt. %. The binder composition may further include a pH adjuster, in an amount of 0 to 10.0 wt. % based on the total solids content of the binder composition.

The binder composition may further include one or more surfactants to assist in binder atomization, wetting, and interfacial adhesion. If present, the surfactant may be included in the binder composition in an amount from 0 to 10 wt. %, including without limitation, amounts from 0.1 wt. % to 5.0 wt. %, or from 0.15 wt. % to 2.0 wt. %, or from 0.2 wt. % to 1.0 wt. %, based on the total solids content in the binder composition. The surfactant is not particularly limited, and includes surfactants such as, but not limited to, ionic surfactants (e.g., sulfate, sulfonate, phosphate, and carboxylate); sulfates (e.g., alkyl sulfates, ammonium lauryl sulfate, sodium lauryl sulfate (SDS), alkyl ether sulfates, sodium laureth sulfate, and sodium myreth sulfate); amphoteric surfactants (e.g., alkylbetaines such as lauryl-betaine); sulfonates (e.g., dioctyl sodium sulfosuccinate, perfluorooctanesulfonate, perfluorobutanesulfonate, and alkyl benzene sulfonates); phosphates (e.g., alkyl aryl ether phosphate and alkyl ether phosphate); carboxylates (e.g., alkyl carboxylates, fatty acid salts (soaps), sodium stearate, sodium lauroyl sarcosinate, carboxylate fluorosurfactants, perfluoronanoate, and perfluorooctanoate); cationic (e.g., alkylamine salts such as laurylamine acetate); pH dependent surfactants (primary, secondary or tertiary amines); permanently charged quaternary ammonium cations (e.g., alkyltrimethylammonium salts, cetyl trimethylammonium bromide, cetyl trimethylammonium chloride, cetylpyridinium chloride, and benzethonium chloride); and zwitterionic surfactants, quaternary ammonium salts (e.g., lauryl trimethyl ammonium chloride and alkyl benzyl dimethylammonium chloride), polyoxyethylenealkylamines, and mixtures thereof.

Suitable nonionic surfactants that can be used in conjunction with the binder composition include polyethers (e.g., ethylene oxide and propylene oxide condensates, which include straight and branched chain alkyl and alkaryl polyethylene glycol and polypropylene glycol ethers and thioethers); alkylphenoxypoly(ethyleneoxy) ethanols having alkyl groups containing from about 7 to about 18 carbon atoms and having from about 4 to about 240 ethyleneoxy units (e.g., heptylphenoxypoly(ethyleneoxy) ethanols, and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers.

In any of the exemplary embodiments, the surfactant may include one or more of Dynol 607, which is a 2,5,8,11-tetramethyl-6-dodecyne-5,8-diol, SURFONYL® 420, SURFONYL® 440, and SURFONYL® 465, which are ethoxylated 2,4,7,9-tetramethyl-5-decyn-4,7-diol surfactants (commercially available from Evonik Corporation (Allentown, Pa.)), Stanfax (a sodium lauryl sulfate), Surfynol 465 (an ethoxylated 2,4,7,9-tetramethyl 5 decyn-4,7-diol), Triton™ GR-PG70 (1,4-bis(2-ethylhexyl) sodium sulfosuccinate), and Triton™ CF-10 (poly(oxy-1,2-ethanediyl), alpha-(phenylmethyl)-omega-(1,1,3,3-tetramethylbutyl) phenoxy).

Optionally, the binder composition may contain a dust suppressing agent to reduce or eliminate the presence of inorganic and/or organic particles which may have adverse impact in the subsequent fabrication and installation of the insulation materials. The dust suppressing agent can be any conventional mineral oil, mineral oil emulsion, natural or synthetic oil, bio-based oil, or lubricant, such as, but not limited to, silicone and silicone emulsions, polyethylene glycol, as well as any petroleum or non-petroleum oil with a high flash point to minimize the evaporation of the oil inside the oven.

If present, the dust suppressing agent may be included in the binder composition in an amount up to 20 wt. % of a dust suppressing agent, including up to 15 wt. %, or up to 12 wt. %. In any of the exemplary embodiments, the binder composition may include between 0 wt. % and 15 wt. % of a dust suppressing agent, including 1 wt. % to 13 wt. %, 2 wt. % to 11 wt. %, 4 wt. % to 9 wt. %, or 5 wt. % to 8 wt. %, including all endpoints and subranges therebetween.

Optionally, the binder composition may include one or more processing aids. The processing aid is not particularly limiting so long as the process aid functions to facilitate the processing of the fiber formation and orientation. The process aid can be used to improve binder application distribution uniformity, to reduce binder viscosity, to increase ramp height after forming, to improve the vertical weight distribution uniformity, and/or to accelerate binder de-watering in both forming and oven curing process. The process aid may be present in the binder composition in an amount from 0 to 15 wt. %, including without limitation, amounts from 0.5 wt. % to 10 wt. %, or from 1 wt. % to 7 wt. % by weight, or from 1.5 wt. % to 5 wt. %, based on the total solids content in the binder composition. In any of the exemplary embodiments, the aqueous binder composition may be substantially or completely free of any processing aids.

Examples of processing aids include defoaming agents, such as, silicone, emulsions and/or dispersions of silicone, dispersions of polydimethylsiloxane (PDMS) fluids, and silica which has been hydrophobized with polydimethylsiloxane or other materials. Further processing aids may include particles made of amide waxes such as ethylene bis-stearamide (EBS) or hydrophobized silica.

Optionally, the binder composition may contain at least one coupling agent. In at least one exemplary embodiment, the coupling agent is a silane coupling agent. The coupling agent(s) may be present in the binder composition in an amount from 0.01 wt. % to 5 wt. % by weight of the total solids in the binder composition, including without limitation, amounts from 0.01 wt. % to 2.5 wt. %, from 0.05 wt. % to 1.5 wt. %, or from 0.1 wt. % to 1 wt. %.

Non-limiting examples of silane coupling agents that may be used in the binder composition may be characterized by the functional groups alkyl, aryl, amino, epoxy, vinyl, methacryloxy, ureido, isocyanato, and mercapto. In exemplary embodiments, the silane coupling agent(s) include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., triethoxyaminopropylsilane; 3-aminopropyl-triethoxysilane and 3-aminopropyl-trihydroxy silane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxysilanes. In one or more exemplary embodiment, the silane is an aminosilane, such as γ-aminopropyltriethoxysilane.

The pH of the binder composition in an un-cured state may be adjusted depending on the intended application, to facilitate the compatibility of the ingredients of the binder composition, or to function with various types of fibers. In any of the exemplary embodiments disclosed herein, when in an un-cured state, the pH of the binder composition has a pH of at least about 2. In such exemplary embodiments, the pH of the binder composition, when in an un-cured state, may be about 2.0-7.0, including between 2.2 and 6.8, and between 2.5 and 6.5. After cure, the pH of the binder composition may rise to at least a pH of 5.5 and up to pH of 8.5. In any of the exemplary embodiments disclosed herein, the cured pH of the binder composition is between 6.0 and 8.0.

The binder composition further includes water to dissolve or disperse the active solids for application onto fibers. Accordingly, prior to cure, the binder composition is an aqueous composition and necessarily includes a certain amount of water. Water may be added in an amount sufficient to dilute the binder composition to a viscosity that is suitable for its application to the reinforcement fibers and to achieve a desired solids content on the fibers.

In any of the exemplary embodiments, the binder composition may also include one or more additives, such as an extender, a crosslinking density enhancer, a deodorant, an antioxidant, a biocide, a moisture resistant agent, or combinations thereof. Optionally, the binder may comprise, without limitation, dyes, pigments, additional fillers, colorants, UV stabilizers, thermal stabilizers, anti-foaming agents, emulsifiers, preservatives (e.g., sodium benzoate), corrosion inhibitors, and mixtures thereof. Other additives may be added to the binder composition for the improvement of process and product performance. Additives may be present in the binder composition from trace amounts (such as <about 0.1% by weight the binder composition) up to about 10% by weight of the total solids in the binder composition.

In any of the embodiments, the reactive diluent, polycarboxylic acid, and optional additives may be combined to form a binder premix, prior to the addition of further binder components. In some aspects, the binder premix may comprise or consist of a polymeric polycarboxylic acid-based cross-linking agent and a reactive diluent present in such amounts as to provide a COOH: OH molar ratio between 1/3 and 3/1.

Exemplary binder premix compositions in accordance with the general inventive concepts are provided in Table 1, below. It is to be appreciated that any compositional range from Exemplary Composition A may be used in combination with any compositional range from Exemplary Composition B, and vice vera.

TABLE 1

| | Exemplary | Exemplary |
|---|---|---|
| | Composition A | Composition B |
| | (wt. % solids) | (wt. % solids) |
| Multifunctional | 30-75 | 40-65 |
| oligomeric polyol(s) | | |
| Polymeric crosslinking agent | 20-70 | 30-60 |
| COOH:OH mole ratio | 3:1-1:3 | 1.5:1-1:1.5 |
| Optional (Secondary) Polyol | 0-30 | 2-15 |

It is generally known and accepted that binder viscosity increases as binder solids content increases. However, the novel binder composition surprisingly maintains a balanced and low viscosity, even at a solids content at or exceeding 70%. For instance, the binder composition in accordance with the present inventive concepts demonstrate a viscosity at a temperature of 25° C. of less than 5,000 cP at 73% solids, including, for example, less than 4,000 cP at 73% solids, less than 3,000 cP at 73% solids, and less than 2,500 cP at 73% solids. Additionally, in some aspects, the binder composition of the present invention demonstrate a viscosity at a temperature of 25° C. of less than 1,200 cP at 65% solids, including, for example, less than 1,100 cP at 65% solids, less than 1,000 cP at 65% solids, less than 750 cP at 65% solids, or less than 500 cP at 65% solids. The viscosity is measured using a Brookfield Rheometer with cone and plate attachment, at a temperature of 25° C. The sample size was 1 mL and the viscosity was measured at RPMs spanning 0.01-250 RPM. The values with torque closest to 50% were used to calculate the viscosity at 50% torque, using a linear regression.

### Insulation Products

The binder compositions disclosed herein may be used to manufacture fibrous insulation products, such as fiberglass or mineral wool insulation products. Thus, aspects of the present inventive concepts are also directed to a method for producing an insulation product and includes the steps of contacting a plurality of such fibers with a binder composition as disclosed herein. The insulation product may comprise a facer on one or both of its major surfaces. The facer may be any type of facing substrate known in the art such as, for example, a nonwoven mat, a foil mat, a polymeric surfacing mat, a woven textile, and the like.

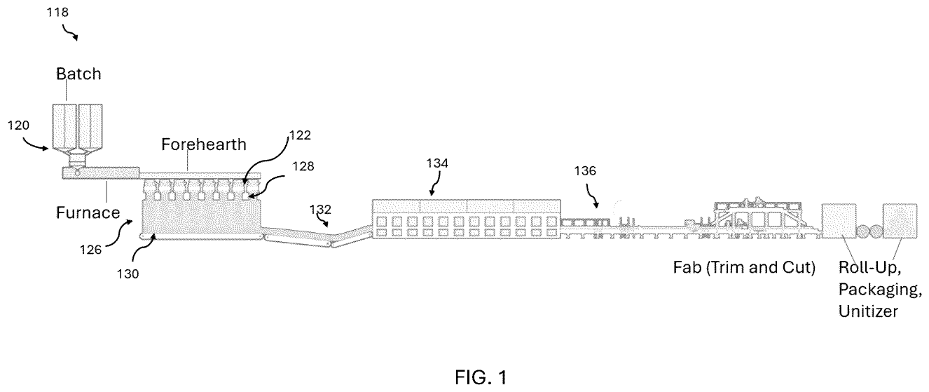

FIG. 1 illustrates an exemplary embodiment of an apparatus 118 for manufacturing a fibrous insulation product. The manufacture of the fibrous insulation product may be carried out in a continuous process by fiberizing molten glass, coating the molten glass fibers with a binder, forming a fibrous glass pack on a moving conveyor, and curing the binder composition to form an insulation blanket as depicted in FIG. 1. A glass batch may be melted in a tank 120 and supplied to a fiber forming device, such as one or more fiberizing spinners 122. Although fiberizing spinners 122 are shown as the fiber forming device in the exemplary embodiment, it should be understood that other types of fiber forming units may be used to form the fibrous insulation product. The fiberizing spinners 122 may comprise spinners that are rotated at high speeds. Centrifugal force causes the molten glass to pass through small orifices in the circumferential sidewalls of the fiberizing spinners 122 to form glass fibers. Glass fibers of random lengths may be attenuated from the fiberizing spinners 122 and blown generally downwardly (i.e., generally perpendicular to the plane of the spinners 122) by blowers 128 positioned within a forming chamber 126.

The blowers 128 turn the glass fibers downward. The glass fibers, while in transit downward in the forming chamber 126 and while still hot from the drawing operation, are sprayed with an aqueous binder composition so as to result in a relatively even distribution of the binder composition throughout the glass fibers. Water may also be applied to the glass fibers in the forming chamber 126, such as by spraying, prior to the application of the binder composition to at least partially cool the glass fibers.

The glass fibers, having the uncured aqueous binder composition adhered thereto, may be gathered and formed into a fibrous pack on a forming conveyor 130 within the forming chamber 125 with the aid of a vacuum (not shown) drawn through the fibrous pack from below the forming conveyor 130. The residual heat from the glass fibers and the flow of air through the fibrous pack during the forming operation are generally sufficient to volatilize a majority of the water from the binder composition before the glass fibers exit the forming chamber 126, thereby leaving the remaining components of the binder composition on the glass fibers as a viscous or semi-viscous high-solids liquid.

The resin-coated fibrous pack, which is in a compressed state due to the flow of air through the fibrous pack in the forming chamber 126, is then transferred out of the forming chamber 126 and onto a ramp 132 where the fibrous pack vertically expands due to the resiliency of the glass fibers. The fibrous pack travels over the ramp 132 and enters a curing oven 134. The expanded fibrous pack is then heated to evaporate any remaining water in the binder composition, cure the binder composition, and rigidly bond the glass fibers together. In order to fully cure the fibrous pack in the curing oven, it is important that the fibrous pack have a moisture content on the ramp (also referred to as “ramp moisture”) below 5%, or below 2%, based on uncured product weight. However, conventional binder chemistries demonstrate that ramp moisture levels of 2% or less result in product property losses, such as reduced recovery and stiffness. However, the inventive binder composition has demonstrated that the ramp moisture may be reduced to less than 2%, less than 1.5%, or even less than 1%, while still producing a fibrous insulation product with sufficient recovery and good performance.

Also, in the curing oven 134, the fibrous pack may be compressed by upper and lower foraminous oven conveyors to form an insulation layer of a predetermined thickness. The upper and lower conveyors may be in a substantially parallel orientation or may alternatively be positioned at an angle relative to each other (not illustrated).

The cured insulation layer exits the curing oven 134 and enters a cooling section 136, whereby the pack may be cooled prior to further processing of the insulation layer, such as by trimming and cutting the layer, rolling the layer, or otherwise packaging the layer for downstream use.

The cured binder composition imparts strength and resiliency to the insulation layer. It is to be appreciated that the drying and curing of the binder composition may be carried out in either one or two different steps. The two stage (two-step) process is commonly known as B-staging. The curing oven 134 may be operated at a temperature from 100° C. to 325° C., or from 250° C. to 300° C. The fibrous pack may remain within the curing oven 134 for a period of time sufficient to crosslink (cure) the binder composition and form the insulation layer.

B-staging is a process wherein a binder-coated fibrous pack is heated to a tackifying temperature without cross-linking, such that the binder composition will stick together and adhere the fibers in the system to form a fibrous precursor. Thus, a B-staged fibrous precursor is an intermediate, yet curable product. Often B-staged products may be exposed to ambient temperatures for an extended period of time, which tends to cause traditional formaldehyde-free B-staged fibrous insulation precursors to dry-out and surface-harden, resulting in poor bond formation between the binder composition and the fibers when shaped into a desired end product. This causes a cured finished product to demonstrate poor tensile strength, due to the poor bonding between the fibers and the binder composition. However, it has been surprisingly discovered that the binder compositions formed in accordance with the present inventive concepts have improved shelf life and fiber wetting properties, even after extended exposure to prolonged ambient conditions.

Fibrous insulation products can be provided in other forms including board (a heated and compressed batt) and molding media (an alternative form of heated and compressed batt) for use in different applications. Fibrous insulation products also include higher density products having densities from about 10 pcf to about 20 pcf, (and often having binder LOI in excess of 12%) and medium density products more typically having a density from about 1 pcf to about 10 pcf, (and having binder LOI of about 5-15%) such as boards and panels. Medium and higher density insulation products may be used in industrial and/or commercial applications, including but not limited to metal building insulation, pipe or tank insulation, insulative ceiling and wall panels, duct boards and HVAC insulation, appliance and automotive insulation, etc.

According to some aspects, the fibrous insulation product may comprise a blanket of binder coated fibers that is formed into rolls or logs of insulation before curing. The formed blanket containing the binder-coated fibers can be further formed into a desired shape and cut into lengths, before it is cured, to better fit equipment and end-use needs. For instance, the blanket containing the binder-coated fibers can be formed into rolls or logs before curing to serve as pipe insulation. As part of this process, after the binder is applied to the blanket, rolls or logs of insulation are formed via a winding machine, the rolls or logs are sawed to the desired size, and then the rolls or logs are stored, and later, cured. This process can require the rolls or logs of insulation be stored for multiple days before they are cured and often experience a longer shelf life.

Formed or shaped products may include a further step, optionally during cure, that compresses, molds or shapes the product to its specific final shape. Rigid boards are a type of shaped product, the shape being planar. Other shaped products may be formed by dies or molds or other forming apparatus. Rigidity may be imparted by the use of higher density of fibers and/or by higher levels of binder application.

Fibrous insulation products may be characterized and categorized by many different properties, one of which is density. Density may range broadly from about 0.2 pounds/cubic foot (“pcf”) to as high as about 10 pcf, depending on the product. Low or light density insulation batts and blankets typically have densities between about 0.2 pcf and about 5 pcf, more commonly from about 0.3 pcf to about 4 pcf, and have application rates of about 2-13% LOI. Products such as residential insulation batts may fall in this group.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

Exemplary binder premixes were prepared comprising polyglycerol and polyacrylic acid in various ratios, as outlined in Table 2. Comparative Samples 1-1 and 1-2 were prepared comprising sorbitol and polyacrylic acid and Comparative Samples 1-3 to 1-6 were prepared comprising various ratios of citric acid and either diglycerol or refined technical grade polyglycerol commercially available from SPIGA Nord. The same diglycerol was used in Samples 1-1 and 1-4 and the diglycerol includes over 90% diglycerol components and has a number average molecular weight between 160-180 Da. Samples 1-2 and 1-5 included the same technical polyglycerol as Comp. Samples 1-6 to 1-8, which includes greater than 50% of triglyerol and lower components and has a molecular weight of 240-260 Da. In Samples 1-3 and 1-6, the polyglycerol-3 is commercially available from SPIGA Nord and is substantially triglycerol-based, with greater than 65% of the oligomer being a triglycerol and lower components, and a number average molecular weight between 240 and 260 Da. The respective binder compositions are listed below and based on the weight percent solids of the binder premix (i.e., excluding additional binder components):

TABLE 2a

| | Comp. | Comp. | Comp. | Comp. | Comp. | Comp. | Comp. | Comp. |
|---|---|---|---|---|---|---|---|---|
| | Sample | Sample | Sample | Sample | Sample | Sample | Sample | Sample |
| | 1-1 | 1-2 | 1-3 | 1-4 | 1-5 | 1-6 | 1-7 | 1-8 |
| | (% solid) | (% solid) | (% solid) | (% solid) | (% solid) | (% solid) | (% solid) | (% solid) |
| Polyacrylic | 71 | 51.7 | — | — | — | — | — | — |
| acid* | | | | | | | | |
| Diglycerol | | | 28.99 | 48.31 | 57.97 | | | |
| Technical PG | | | | | | 28.99 | 48.31 | 57.97 |
| Citric Acid | — | | 67.63 | 48.31 | 38.65 | 67.63 | 48.31 | 38.65 |
| Sorbitol | 29 | 48.3 | — | — | — | — | | |
| Sodium | — | — | 3.38 | 3.38 | 3.38 | 3.38 | 3.38 | 3.38 |
| hypophosphite | | | | | | | | |
| COOH:OH | 0.92:1 | 0.39:1 | 1.59:1 | 0.68:1 | 0.46:1 | 1.86:1 | 0.80:1 | 0.53:1 |
| (moles) | | | | | | | | |
| Binder solids | 24.81 | — | 30.49 | 30.53 | 30.57 | 30.54 | 30.75 | 30.28 |
| Cure Yield | 90.59% | 25.36% | 58.15% | 75.50% | 76.29% | 55.66% | 68.84% | 71.99% |
| (%) @ 425° F. | | | | | | | | |

*Includes 4.7 wt. % sodium hypophosphite on a dry solids basis, based on the total dry solids of polyacrylic acid.

TABLE 2b

| | Sample | Sample | Sample | Sample | Sample | Sample |
|---|---|---|---|---|---|---|
| | 1-1 (% | 1-2 (% | 1-3 (% | 1-4 (% | 1-5 (% | 1-6 (% |
| | solid) | solid) | solid) | solid) | solid) | solid) |
| Polyacrylic | 64.1 | 60.2 | 61.2 | 54.3 | 50.2 | 51.3 |
| acid* | | | | | | |
| Diglycerol | 35.9 | | | 45.7 | | |
| Technical PG | | 39.8 | | | 49.8 | |
| Polyglycerol -3 | | | 38.8 | | | 48.7 |
| COOH:OH | 1:1 | 1:1 | 1:1 | 1:1.5 | 1:1.5 | 1:1.5 |
| (moles) | | | | | | |
| Binder solids | 34.39 | 34.22 | 34.46 | 34.28 | 34.27 | 34.53 |
| Cure Yield (%) | 90.88% | 90.62% | 91.28% | 90.83% | 90.47% | 93.23% |
| @ 425° F. | | | | | | |

*Includes 4.7 wt. % sodium hypophosphite on a dry solids basis, based on the total dry solids of polyacrylic acid.

As illustrated in Table 2 (b), Samples 1-1-1-6 achieved cure yields that are comparable to Comparative Sample 1-1, while including a reduced amount of polyacrylic acid. It is generally accepted that a high concentration of polyacrylic acid is needed in binder compositions such as these in order to achieve a quality insulation product (see Comparative Sample 1-1 vs Comparative Sample 1-2). However, Sample 1-1 reduces the concentration of polyacrylic acid from 71 wt. % to 64.1 wt. % and Sample 1-2 reduces the polyacrylic acid concentration further to 60.2 wt. % and each achieved cure yields higher than Comparative Sample 1-1 and 1-2. It is believed that this improvement is due at least in part to the liquid nature of polyglycerol at high solids concentrations, which improves the distribution and processing of the insulation products. As polyacrylic acid is highly corrosive, reducing its presence in the binder composition while maintaining performance is desirable. Thus, the binder composition is able to increase the ratio of OH:COOH (i.e., reducing the amount of acid), while maintaining a high yield (See Samples 1-1 to 1-6).

### Example 2

Various binder premixes were prepared as outlined in Table 3. Comparative Examples 2-1 and 2-2 included varying ratios of polyacrylic acid and sorbitol. Examples 2-1 and 2-2 included varying ratios of diglycerine and polyacrylic acid. Example 2-3 included polyacrylic acid and polyglycerol. The respective binder compositions are based on the weight percent solids of the binder premix (i.e., excluding additional binder components). Each binder pre-mix was then blended with 3.5 wt. % sodium hypophosphite, 0.2 wt. % hydrolyzed silane, and 0.5 wt. % surfactant.

TABLE 3

| | Comp. | Comp. | Ex. | Ex. | Ex. |
|---|---|---|---|---|---|
| | Ex. 3-1 | Ex. 3-2 | 2-1 | 2-2 | 2-3 |
| PAA | 70 | 50 | 62.96 | 53.08 | 48.97 |
| Sorbitol | 30 | 50 | | | |
| Diglycerine | | | 37.04 | 46.92 | |
| (90% + diglycerol) | | | | | |
| Technical Grade PG | | | | | 51.03 |
| (50% + di-and tri-glycerol) | | | | | |
| COOH:OH (mole ratio) | 0.92:1 | 0.39:1 | 1:1 | 1:1.5 | 1:1.5 |

The binder compositions in Table 3 were then used to prepare hand sheets in accordance with the following procedure. First, about 6,000 grams of DI water is added to a bucket and placed on a high-speed mixer. To this water, about 100 grams of a dispersant, such as Nalco 7768, was added and the mixture was mixed for at least 15 minutes, forming a dispersant mixture. Another bucket was then filled with water and 8 drops of the dispersant mixture and 8 grams of wet chop glass fibers were added and allowed to stir for 5 minutes.

Separately, a screen catch was placed in a 12×12×12-inch 40 liter Williams standard pulp testing apparatus (a.k.a. a deckle box) and the box was closed. The deckle box was then filled with water to the “3” mark and 80 grams of a viscosity modifier (e.g., polyacrylamide, such as NALCLEAR® 7768, commercially available from the Nalco Company) was mixed into the water until dissolved. After the glass fiber water had stirred for 5 minutes, 80 grams of the viscosity mixture was added and stirred at low speed for one minute, after which the stirring speed was set to the highest setting and allowed to stir for an additional 2 minutes. The glass fiber solution is then immediately dumped into the deckle box and stirred for 10 rapid strokes. At this point, the valve on the deckle box was depressed until the deckle box was empty. After the deckle box was drained, the box was opened and the screen with the handsheet was removed from the base by holding opposite corners of the screen. The screen was then placed on a wooden frame and the binder compositions were individually applied to the handsheets using a roll coater. Excess binder was then vacuumed off.

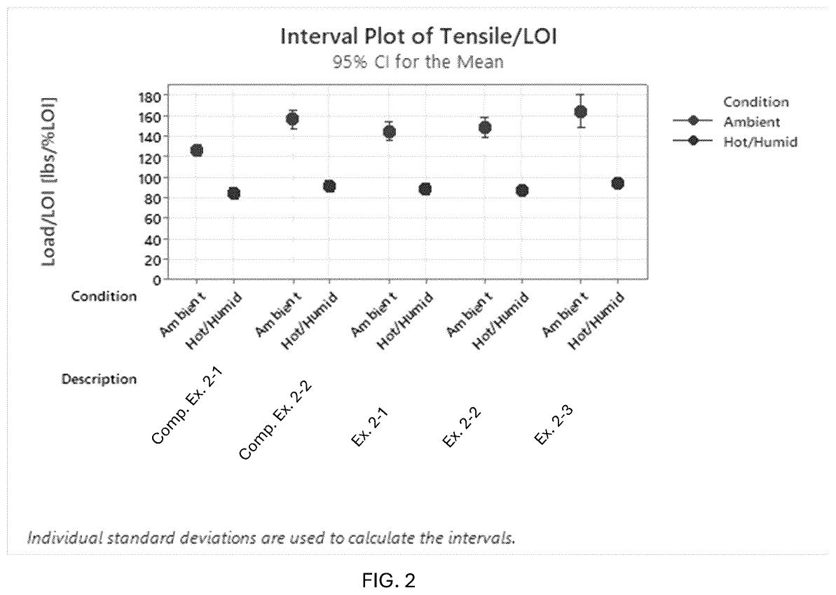

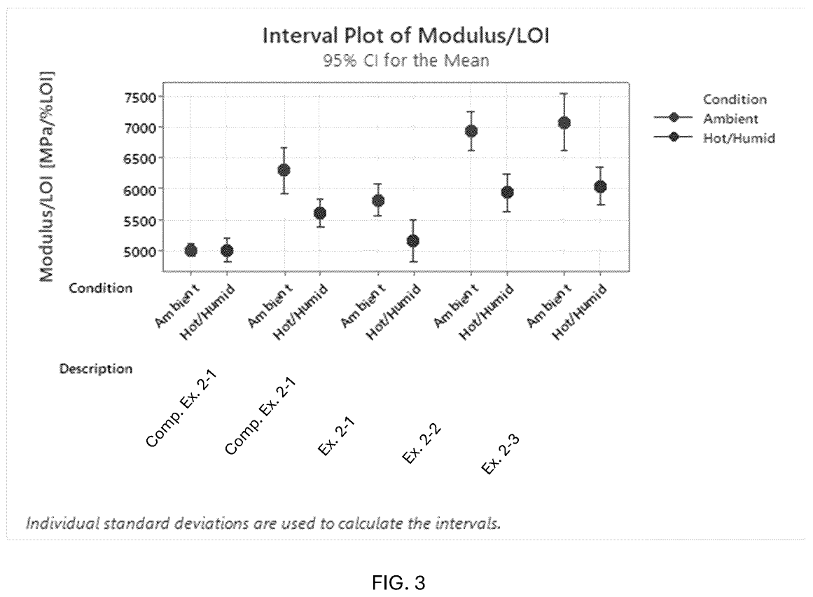

The binder-coated handsheets were placed into an oven for curing at 425° F. for 3.5 minutes and then cut into 1-inch strips. The handsheets had an LOI of about 8% and were cut into 1-inch wide strips. The 1-inch wide strips were tested for Young's modulus/LOI and tensile strength (load/LOI) at ambient conditions and after conditioning under hot/humid (autoclave) conditions at 90° F. at 90% relative humidity for at least 17 hours. The results are provided in FIGS. 2-3.

As illustrated in FIG. 2, Samples 2-1, 2-2, and 2-3 each achieved better load/LOI performance than Comparative Sample 2-1.

### Example 3

Various binder premixes were prepared as outlined in Table 4. Comparative Examples 3-1 and 3-2 included varying ratios of polyacrylic acid and polyglycerol-6 and 10 (each with greater than 50% of tetraglycerol or higher components (hexa-, hepta-, etc.)). Examples 3-1 and 3-2 included varying ratios of diglycerine or polyglycerol-3 and polyacrylic acid.

TABLE 4

| | Comp. | Comp. | Ex. | Ex. |
|---|---|---|---|---|
| | Ex. 3-1 | Ex. 3-2 | 3-1 | 3-2 |
| Polyacrylic acid | 57 | 52 | 64 | 60 |
| Diglycerine (90% + diglycerol) | | | 36 | |
| with Hydroxyl Number of | | | | |
| 1280 mg KOH/g | | | | |
| PG-3 (65% + di- and tri- | | | | 40 |
| glycerol) with Hydroxyl | | | | |
| Number of 1100 mg KOH/g | | | | |
| PG-6 (67.4% tetraglycerol | 43 | | | |
| and higher) with Hydroxyl | | | | |
| Number of 950 mg KOH/g | | | | |
| PG-10 (87.9% tetraglycerol | | 48 | | |
| and higher) with Hydroxyl | | | | |
| Number of 800 mg KOH/g | | | | |
| COOH:OH | 1:1 | 1:1 | 1:1 | 1:1.5 |
| % Reacted COOH | 57% | 60.5% | 73.5% | 63.4% |
| Crosslink Density (mol/g), | 0.0047 | 0.0046 | 0.0070 | 0.0056 |
| cured at 450° F. | | | | |

Three grams of the compositions (10% solids) in Table 4 were then cured in a pan for 10 minutes and weighed before and after curing. The crosslinking density for each sample was calculated from the amount of mass loss during curing:

Cure Yield %=(Final Weight)/(Initial Weight×% Solids)×100%. The amount of crosslinking that occurred can be measured in accordance with the following equations: % Reacted COOH=((1−Cure Yield %))/((1−Theoretical Yield %))×100%, with the theoretical yield determined in accordance with the following equation: Theoretical Yield %=100%−(18/(COOH Mol Equiv. Wt.+OH Mol Equiv. Wt.)×100%). Additionally, crosslinking density can be calculated from: Crosslinking density (mol/g)=[(Initial Weight in g)−(Final Weight in g)]/[18 g/mol*(Final Weight in g)].

The crosslink density illustrates the amount of COOH in the system that participated in esterification. It is believed that the reaction is able to progress further with the smaller polyglycerols due to reactive groups being in closer proximity to one another.

It will be appreciated that many more detailed aspects of the illustrated products and processes are in large measure, known in the art, and these aspects have been omitted for purposes of concisely presenting the general inventive concepts. Although the present invention has been described with reference to particular means, materials and embodiments, from the foregoing description, one skilled in the art can easily ascertain the essential characteristics of the present disclosure and various changes and modifications can be made to adapt the various uses and characteristics without departing from the spirit and scope of the present invention as described above and set forth in the attached claims.

The following paragraphs provide further exemplary embodiments.

Paragraph 1. A fibrous insulation product comprising a plurality of randomly oriented fibers; and a binder composition at least partially coating the fibers, characterized in that, prior to cure, the binder composition is an aqueous composition comprising: at least 35 wt. % of a reactive diluent polyol having a mol-equivalent weight per OH group of at least 40; 20 wt. % to less than 70 wt. % of a polymeric crosslinking agent; wherein the aqueous binder composition has a viscosity that is at least 10% less than a substantially similar aqueous binder composition that includes monomeric polyol rather than a multifunctional oligomeric polyol, at the same temperature and solids content.

Paragraph 2. The fibrous insulation product of paragraph 1, wherein the reactive diluent polyol is a multifunctional oligomeric polyol having a degree of polymerization of 2, 3, 4, or 5.

Paragraph 3. The fibrous insulation product of paragraph 1 or paragraph 2, wherein the reactive diluent polyol comprises polyglycerol.

Paragraph 4. The fibrous insulation product of any one of paragraph 1 to 3, wherein the reactive diluent polyol has a mol-equivalent weight per OH group of at least 45.

Paragraph 5. The fibrous insulation product of any one of paragraph 1 to 4, wherein the reactive diluent polyol is a liquid at a solids content of 75% and above at ambient temperature.

Paragraph 6. The fibrous insulation product of any one of paragraph 1 to 5, wherein the reactive diluent polyol is a liquid at a solids content of 85% and above at ambient temperature.

Paragraph 7. The fibrous insulation product of any one of paragraph 1 to 6, wherein the aqueous binder composition has a viscosity that is at least 20% less than a substantially similar aqueous binder composition that includes monomeric polyol rather than a multifunctional oligomeric polyol, at the same temperature and solids content.

Paragraph 8. The fibrous insulation product of any one of paragraph 1 to 7, wherein the aqueous binder composition has a viscosity at a temperature of 25° C. of less than 5,000 cP at 73% solids.

Paragraph 9. The fibrous insulation product of any preceding paragraph, wherein the binder composition further includes a secondary polyol comprising one or more of a sugar alcohol, pentaerythritol, and alkanolamine.

Paragraph 10. The fibrous insulation product of paragraph 9, wherein the secondary polyol is included in the binder composition in an amount less than 30 wt. %.

Paragraph 11. The fibrous insulation product of any one of paragraph 1 to 10, wherein the crosslinking agent, reactive diluent polyol, and any optional secondary polyols are present in amounts such that the ratio of the number of molar equivalents of carboxylic acid groups, anhydride groups, or salts thereof to the number of molar equivalents of hydroxyl groups (COOH: OH) is from about 1:3 to about 3:1.

Paragraph 12. The fibrous insulation product of any one of paragraph 1 to 11, wherein the crosslinking agent, reactive diluent polyol, and any optional secondary polyols are present in amounts such that the ratio of the number of molar equivalents of carboxylic acid groups, anhydride groups, or salts thereof to the number of molar equivalents of hydroxyl groups (COOH: OH) is from about 1.5:1 to 1:1.5.

Paragraph 13. The fibrous insulation product of any one of paragraph 1 to 12, wherein the binder composition has no greater than 6% by weight of water-soluble material after cure.

Paragraph 14. The fibrous insulation product of any preceding claim, wherein the fibers are glass fibers.

Paragraph 15. The fibrous insulation product of paragraph 14, wherein the glass fibers have an average fiber diameter of 15 HT or less.

Paragraph 16. The fibrous insulation product of any preceding paragraph, wherein the fibrous insulation product comprises pipe insulation.

Paragraph 17. An aqueous binder composition for forming a fibrous insulation product, characterized in that the binder composition has a viscosity at a temperature of 25° C. of less than 5,000 cP at 73% solids, the binder composition comprising:
at least 35 wt. % of a reactive diluent polyol, wherein the reactive diluent polyol has a mol-equivalent weight per OH group of at least 40 and is substantially in liquid form at a solids content of 75% or above at ambient temperature; and
20 wt. % to 70 wt. % by weight of a polymeric crosslinking agent comprising at least two carboxylic acid groups.

Paragraph 18. The aqueous binder composition of paragraph 17, wherein the reactive diluent polyol is substantially in liquid form at a solids content of above 95% at ambient temperature.

Paragraph 19. The aqueous binder composition of paragraph 17 or 18, wherein the reactive diluent polyol is a multifunctional oligomeric polyol having a degree of polymerization of 2, 3, 4, or 5.

Paragraph 20. The aqueous binder composition of any one of paragraph 17 to 19, wherein the reactive diluent polyol comprises polyglycerol.

Paragraph 21. The aqueous binder composition of any one of paragraph 17 to 20, wherein the aqueous binder composition has a viscosity that is at least 20% less than a substantially similar aqueous binder composition that includes a monomeric polyol rather than a multifunctional oligomeric polyol, at the same temperature and solids content.

Paragraph 22. The aqueous binder composition of any one of paragraph 17 to 21, wherein the aqueous binder composition has a viscosity at a temperature of 25° C. of less than 4,000 cP at 73% solids.

Paragraph 23. The aqueous binder composition of any one of paragraph 17 to 22, wherein the binder composition further includes a secondary polyol comprising one or more of a sugar alcohol, pentaerythritol, and alkanolamine.

Paragraph 24. The aqueous binder composition of paragraph 23, wherein the secondary polyol is included in the binder composition in an amount less than 30 wt. %.

Paragraph 25. The aqueous binder composition of any one of paragraph 17 to 24, wherein the crosslinking agent, reactive diluent polyol, and any optional secondary polyols are present in amounts such that the ratio of the number of molar equivalents of carboxylic acid groups, anhydride groups, or salts thereof to the number of molar equivalents of hydroxyl groups (COOH: OH) is from about 1:3 to about 3:1.

Paragraph 26. The aqueous binder composition of any one of paragraph 17 to 25, wherein the crosslinking agent, reactive diluent polyol, and any optional secondary polyols are present in amounts such that the ratio of the number of molar equivalents of carboxylic acid groups, anhydride groups, or salts thereof to the number of molar equivalents of hydroxyl groups (COOH: OH) is from about 1.5:1 to 1:1.5.

Paragraph 27. The aqueous binder composition of any one of paragraph 17 to 26, wherein the binder composition has no greater than 6% by weight of water-soluble material after cure.

Paragraph 28. A method for forming a fibrous insulation product comprising:
forming an uncured insulation blanket from a plurality of randomly oriented fibers at least partially coated with an aqueous binder composition, the aqueous binder composition comprising:
   at least 35 wt. % of a reactive diluent polyol, wherein the reactive diluent polyol has a mol-equivalent weight per OH group of at least 40 and is substantially in liquid form at a solids content of 75% or above at ambient temperature; and
   20 wt. % to 70 wt. % by weight of a polymeric crosslinking agent comprising at least two carboxylic acid groups; and
curing the insulation blanket to form a fibrous insulation product.

Paragraph 29. The method of paragraph 28, wherein the fibrous insulation product is uncured pipe insulation.

Paragraph 30. The method of any one of paragraph 28 or 29, wherein the step of curing the insulation product occurs after at least 2 days.

Paragraph 31. The method of any of paragraph 28 to 30, wherein the reactive diluent polyol is substantially in liquid form at a solids content of above 95%.

Paragraph 32. The method of any of paragraph 23 to 30, wherein the reactive diluent polyol comprises polyglycerol.

What is claimed is:

1. A fibrous insulation product comprising:
a plurality of randomly oriented fibers; and
a binder composition at least partially coating the fibers, characterized in that, prior to cure, the binder composition is an aqueous composition comprising:
at least 35 wt. % of a reactive diluent polyol having a mol-equivalent weight per OH group of at least 40;
20 wt. % to less than 70 wt. % of a polymeric crosslinking agent;
wherein the aqueous binder composition has a viscosity that is at least 10% less than a substantially similar aqueous binder composition that includes monomeric polyol rather than a multifunctional oligomeric polyol, at the same temperature and solids content.

2. The fibrous insulation product of claim 1, wherein the reactive diluent polyol is a multifunctional oligomeric polyol having a degree of polymerization of 2, 3, 4, or 5.

3. The fibrous insulation product of claim 1, wherein the reactive diluent polyol comprises polyglycerol.

4. The fibrous insulation product of claim 1, wherein the reactive diluent polyol has a mol-equivalent weight per OH group of at least 45.

5. The fibrous insulation product of claim 1, wherein the reactive diluent polyol is a liquid at a solids content of 75% and above at ambient temperature.

6. The fibrous insulation product of claim 1, wherein the aqueous binder composition has a viscosity that is at least 20% less than a substantially similar aqueous binder composition that includes monomeric polyol rather than a multifunctional oligomeric polyol, at the same temperature and solids content.

7. The fibrous insulation product of claim 1, wherein the aqueous binder composition has a viscosity at a temperature of 25° C. of less than 5,000 cP at 73% solids.

8. The fibrous insulation product of claim 1, wherein the binder composition further includes a secondary polyol comprising one or more of a sugar alcohol, pentaerythritol, and alkanolamine.

9. The fibrous insulation product of claim 1, wherein the crosslinking agent, reactive diluent polyol, and any optional secondary polyols are present in amounts such that the ratio of the number of molar equivalents of carboxylic acid groups, anhydride groups, or salts thereof to the number of molar equivalents of hydroxyl groups (COOH: OH) is from about 1:3 to about 3:1.

10. The fibrous insulation product of claim 1, wherein the binder composition has no greater than 6% by weight of water-soluble material after cure.

11. The fibrous insulation product of claim 1, wherein the fibers are glass fibers.

12. The fibrous insulation product of claim 1, wherein the fibrous insulation product comprises pipe insulation.

13. An aqueous binder composition for forming a fibrous insulation product, characterized in that the binder composition has a viscosity at a temperature of 25° C. of less than 5,000 cP at 73% solids, the binder composition comprising:
at least 35 wt. % of a reactive diluent polyol, wherein the reactive diluent polyol has a mol-equivalent weight per OH group of at least 40 and is substantially in liquid form at a solids content of 75% and above at ambient temperature; and
20 wt. % to 70 wt. % by weight of a polymeric crosslinking agent comprising at least two carboxylic acid groups.

14. The aqueous binder composition of claim 13, wherein the reactive diluent polyol is substantially in liquid form at a solids content of 95% and above at ambient temperature.

15. The aqueous binder composition of claim 13, wherein the reactive diluent polyol is a multifunctional oligomeric polyol having a degree of polymerization of 2, 3, 4, or 5.

16. The aqueous binder composition of claim 13, wherein the reactive diluent polyol comprises polyglycerol.

17. The aqueous binder composition of claim 13, wherein the aqueous binder composition has a viscosity at a temperature of 25° C. of less than 4,000 cP at 73% solids.

18. The aqueous binder composition of claim 13, wherein the binder composition has no greater than 6% by weight of water-soluble material after cure.

19. A method for forming a fibrous insulation product comprising:
forming an uncured insulation blanket from a plurality of randomly oriented fibers at least partially coated with an aqueous binder composition, the aqueous binder composition comprising:
at least 35 wt. % of a reactive diluent polyol, wherein the reactive diluent polyol has a mol-equivalent weight per OH group of at least 40 and is substantially in liquid form at a solids content above 75% at ambient temperature; and
20 wt. % to 70 wt. % by weight of a polymeric crosslinking agent comprising at least two carboxylic acid groups; and
curing the insulation blanket to form a fibrous insulation product.

20. The method of claim 19, wherein the step of curing the insulation product occurs after at least 2 days.
